(19) United States
(12) Patent Application Publication
(10) Pub. No.: US 2024/0323576 A1
(43) Pub. Date: Sep. 26, 2024

(54) SPEAKER VIBRATION ISOLATOR

(71) Applicant: DENSO CORPORATION, Kariya-city (JP)

(72) Inventor: Kouzou ONO, Kariya-city (JP)

(21) Appl. No.: 18/732,138

(22) Filed: Jun. 3, 2024

Related U.S. Application Data
(63) Continuation of application No. PCT/JP2022/043258, filed on Nov. 23, 2022.

(30) Foreign Application Priority Data
Dec. 6, 2021 (JP) 2021-198052

(51) Int. Cl. H04R 1/02

(52) U.S. Cl. CPC H04R 1/025

(57) ABSTRACT

A speaker vibration isolator is configured to receive a speaker having a plurality of speaker projections. Each speaker projection radially projects from a speaker main body and has a through-hole configured to receive a screw. The speaker vibration isolator is made of an elastic material and includes: a receiver ring that surrounds an outer peripheral surface of the speaker; and a plurality of retainers that correspond to the plurality of speaker projections, respectively. Each retainer contacts a front surface of the corresponding speaker projection and urges the corresponding speaker projection toward the receiver ring.

### CROSS REFERENCE TO RELATED APPLICATIONS

This application is a continuation application of International Patent Application No. PCT/JP2022/043258 filed on Nov. 23, 2022, which designated the U.S. and claims the benefit of priority from Japanese Patent Application No. 2021-198052 filed on Dec. 6, 2021. The entire disclosures of all of the above applications are incorporated herein by reference.

### TECHNICAL FIELD

The present disclosure relates to a speaker vibration isolator that limits transmission of vibrations generated from a speaker.

### BACKGROUND

Previously, there has been proposed a structure that fixes a speaker. At this structure, the speaker is fixed to a speaker cabinet with screws, and a vibration isolation bushing is interposed between the speaker cabinet and a front cabinet to which the speaker cabinet is attached. This vibration isolation bushing reduces the amount of vibrations, which are generated by the speaker and are transmitted to the front cabinet.

### SUMMARY

This section provides a general summary of the disclosure, and is not a comprehensive disclosure of its full scope or all of its features.

According to the present disclosure, there is provided a speaker vibration isolator configured to receive a speaker having a plurality of speaker projections. The speaker vibration isolator is made of an elastic material and includes a receiver ring and a plurality of retainers. The receiver ring is configured to surround an outer peripheral surface of the speaker. The plurality of retainers correspond to the plurality of speaker projections, respectively. Each of the plurality of retainers is configured to contact a front surface of a corresponding one of the plurality of speaker projections and urge the corresponding one of the plurality of speaker projections toward the receiver ring.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram showing a state where a speaker unit is installed to a meter unit.

FIG. 2 is a diagram showing an assembling method of the speaker unit.

FIG. 3 is a diagram showing a state where the speaker unit is installed to a lower case.

FIG. 4 is a diagram showing a back side of a speaker.

FIG. 5 is a plan view of a speaker vibration isolator.

FIG. 6 is a plan view of the speaker unit.

FIG. 7 is a cross-sectional view taken along line VII-VII in FIG. 6.

FIG. 8 is a bottom view of the speaker vibration isolator.

FIG. 9 is a diagram for describing a dimensional relationship between a speaker projection and each corresponding portion of the speaker vibration isolator which is opposed to the speaker projection.

FIG. 10 is a cross-sectional view taken along line X-X in FIG. 6.

FIG. 11 is a cross-sectional view taken along line XI-XI in FIG. 6.

FIG. 12 is a perspective view showing a back surface of a speaker vibration isolator of a second embodiment.

FIG. 13 is a diagram showing a surface of the speaker vibration isolator.

FIG. 14 is a plan view showing a state where the speaker is held by the speaker vibration isolator.

FIG. 15 is a cross-sectional view taken along line XV-XV in FIG. 14.

FIG. 16 is a cross-sectional view taken along line XVI-XVI in FIG. 14.

### DETAILED DESCRIPTION

Previously, there has been proposed a structure that fixes a speaker. At this structure, the speaker is fixed to a speaker cabinet with screws, and a vibration isolation bushing is interposed between the speaker cabinet and a front cabinet to which the speaker cabinet is attached. This vibration isolation bushing reduces the amount of vibrations, which are generated by the speaker and are transmitted to the front cabinet.

The vibration isolation using the vibration isolation bushing is not sufficient to limit the transmission of the vibrations.

According to the present disclosure, there is provided a speaker vibration isolator configured to receive a speaker having a plurality of speaker projections, wherein each of the plurality of speaker projections radially projects from a speaker main body of the speaker and has a through-hole configured to receive a screw through the through-hole, the speaker vibration isolator being made of an elastic material and including:
a receiver ring that is configured to surround an outer peripheral surface of the speaker; and
a plurality of retainers that correspond to the plurality of speaker projections, respectively, wherein each of the plurality of retainers is configured to contact a front surface of a corresponding one of the plurality of speaker projections and urge the corresponding one of the plurality of speaker projections toward the receiver ring.

Since the speaker vibration isolator is entirely made of the elastic material, it is possible to limit transmission of the vibrations, which are generated at the speaker, to a member, such as a mounting member.

In addition, since each of the plurality of retainers urges the corresponding one of the plurality of speaker projections toward the receiver ring, the speaker vibration isolator can effectively hold the speaker. Since the speaker vibration isolator holds the speaker in the above-described manner, the coupling between the speaker and the speaker vibration isolator is weaker than that of a case where the speaker is fixed with the screws. Since the coupling described above is weak, it is possible to limit the transmission of the vibrations, which are generated at the speaker, to the other member, such as the mounting member, through the speaker vibration isolator. Thus, the speaker vibration isolator has the high vibration isolating effect.

In addition, since the speaker vibration isolator holds the speaker in the above-described manner, a standard speaker, which has the speaker projections each having the through-hole for secure attachment with the screw, can be used.

Hereinafter, embodiments of the present disclosure will be described with reference to the drawings.

### First Embodiment

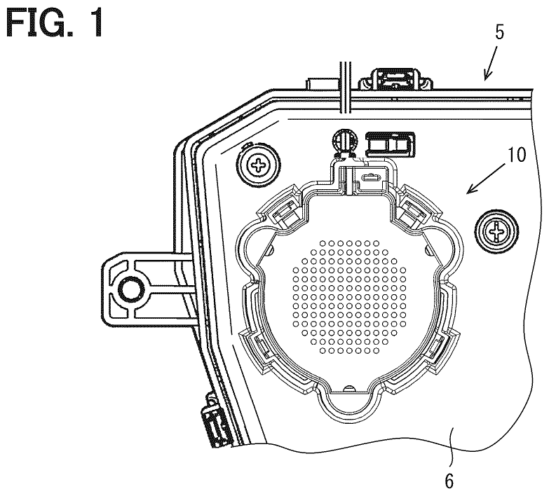

FIG. 1 shows a speaker unit 10 that includes a speaker vibration isolator 100 of the present embodiment. The speaker unit 10 is installed to a meter unit 5 of, for example, a vehicle (e.g., an automobile). In the present embodiment, a mounting member, to which the speaker unit 10 is mounted, is a lower case 6 of the meter unit 5.

### (Summary of Mounting Method)

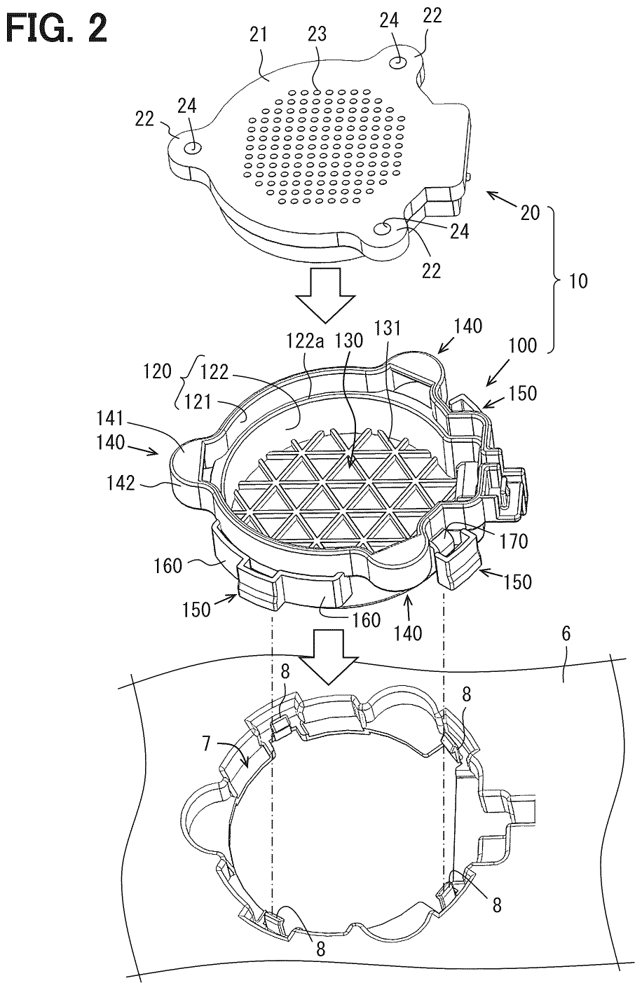

FIG. 2 is a diagram showing an assembling method of the speaker unit 10. The speaker unit 10 includes: a speaker 20; and the speaker vibration isolator 100 that receives the speaker 20. The speaker unit 10 is received in a unit receiver 7 formed at the lower case 6.

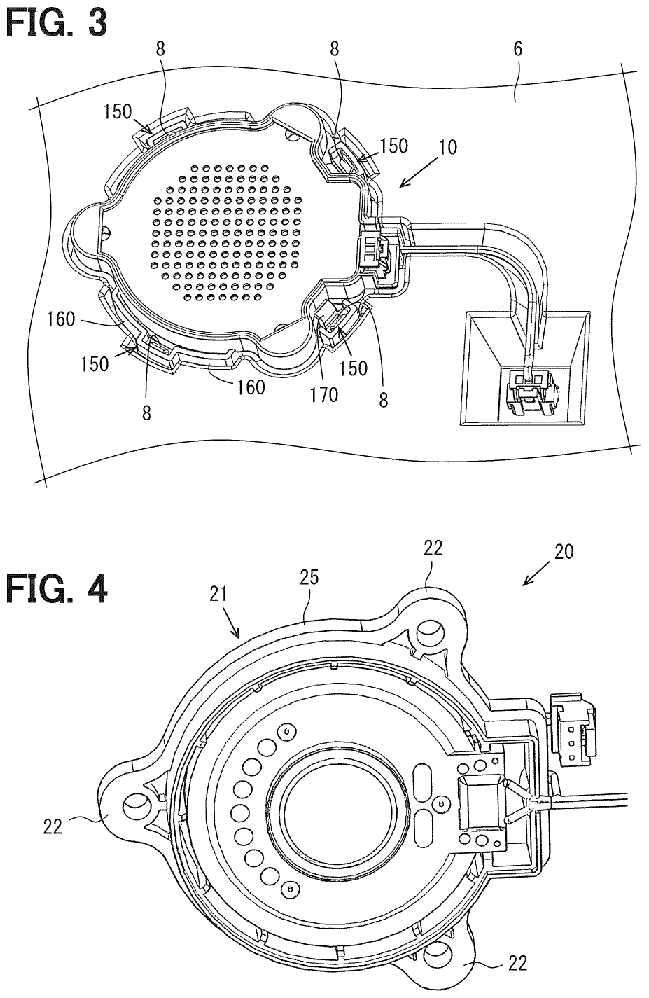

The unit receiver 7 has a plurality of planar pawls (in this instance, four planar pawls) 8 that are configured to engage with a plurality of connectors (in this instance, four connectors) 150 of the speaker vibration isolator 100, respectively (see, for example, FIG. 2). When the connectors 150 of the speaker vibration isolator 100 are engaged with the planar pawls 8, the speaker unit 10 is mounted to the lower case 6, as shown in FIG. 3.

### (Structure of Speaker 20)

As shown in FIG. 2, the speaker 20 includes a speaker main body 21 and a plurality of speaker projections 22. The speaker main body 21 is shaped generally in a circular disk form. The speaker main body 21 has a plurality of sound output holes 23 through which sound is outputted. A side of the speaker 20, which has the sound output holes 23, is defined as a front side of the speaker 20. Hereafter, unless otherwise stated, the term “front side” is based on the speaker 20, and a front surface refers to a surface of a subject member located on the front side, and a back surface refers to a surface of the subject member opposite to the front surface.

The speaker projections 22 radially outwardly project from the speaker main body 21. Each speaker projection 22 is generally shaped in a semi-circular form when the speaker projection 22 is seen from its front side. The number of the speaker projections 22 is three, and these three speaker projections 22 are arranged at equal intervals in the circumferential direction, i.e., are located at positions that divide the speaker main body 21 into three equal parts in the circumferential direction. Each speaker projection 22 has a through-hole 24 which is configured to receive a screw through the through-hole 24. However, in the present embodiment, the speaker 20 is mounted to the speaker vibration isolator 100 without using the screws.

The speaker 20 is configured to be fixed to a predetermined member by inserting the screws into the through-holes 24 of the speaker projections 22. The speaker 20, which has the speaker projections 22 each having the through-hole 24 for secure attachment with the screw, is a standard speaker (a mass marketed speaker) and is available at low costs.

FIG. 4 shows the back side of the speaker 20. On the front side of the speaker main body 21 in the axial direction, a speaker flange 25 radially outwardly projects from the speaker main body 21. A thickness of each of the speaker projections 22 is the same as a thickness of the speaker flange 25, and the speaker projections 22 radially outwardly project from the speaker flange 25.

### (Structure of Speaker Vibration Isolator 100)

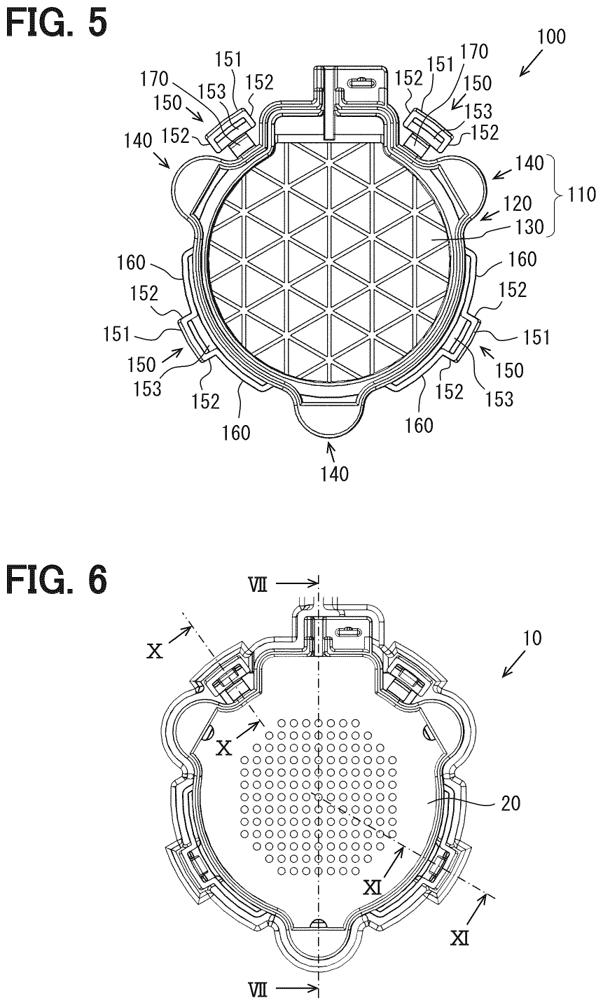

Next, a structure of the speaker vibration isolator 100 will be described. The speaker vibration isolator 100 is formed in one-piece and is entirely made of an elastic material, such as rubber. As shown in FIG. 5, the speaker vibration isolator 100 has a speaker receiver 110. The speaker receiver 110 receives the speaker 20. The speaker receiver 110 has a receiver ring 120, a receiver bottom 130 and a plurality of retainers 140. The speaker vibration isolator 100 also has the connectors 150, a plurality of circumferential links (in this instance, two circumferential links) 160 and a plurality of axial links (in this instance, two axial links) 170.

The receiver ring 120 is shaped in a ring form and surrounds an outer peripheral surface of the speaker 20. The receiver bottom 130 is generally shaped in a circular disk form and closes an end part of the receiver ring 120 which faces in the axial direction. Each of the retainers 140 is configured to hold a corresponding one of the speaker projections 22 and thereby limit detachment of the speaker 20 from the speaker vibration isolator 100. Each of the connectors 150 is configured to engage with a corresponding one of the planar pawls 8 of the lower case 6. Each of the circumferential links 160 and the axial links 170 couples between the receiver ring 120 and a corresponding one of the connectors 150.

Hereinafter, the structure of the speaker vibration isolator 100 will be described in detail. The receiver ring 120 has: a front-side receiver portion 121 which receives the speaker flange 25; and a back-side receiver portion 122 which receives a portion of the speaker main body 21 that does not have the speaker flange 25.

The front-side receiver portion 121 is shaped in a ring form and has an inner diameter that is slightly larger than an outer diameter of the speaker flange 25. The back-side receiver portion 122 is shaped in a ring form and has an inner diameter that is larger than an outer diameter of the portion of the speaker main body 21 which does not have the speaker flange 25. A wall thickness of the back-side receiver portion 122 is set such that an outer diameter of the back-side receiver portion 122 is larger than the inner diameter of the front-side receiver portion 121, and the inner diameter of the back-side receiver portion 122 is smaller than the inner diameter of the front-side receiver portion 121. Thereby, an end surface 122a of the back-side receiver portion 122, which is adjacent to the front-side receiver portion 121, is exposed at an inside of the front-side receiver portion 121. A back surface of the speaker flange 25 contacts the end surface 122a to set a relative position of the speaker 20 relative to the speaker vibration isolator 100 in the axial direction.

The receiver bottom 130 is shaped in a circular disk form and closes an end part of the back-side receiver portion 122 which is opposite to the front-side receiver portion 121. A plurality of ribs 131 are formed at an inner surface of the receiver bottom 130.

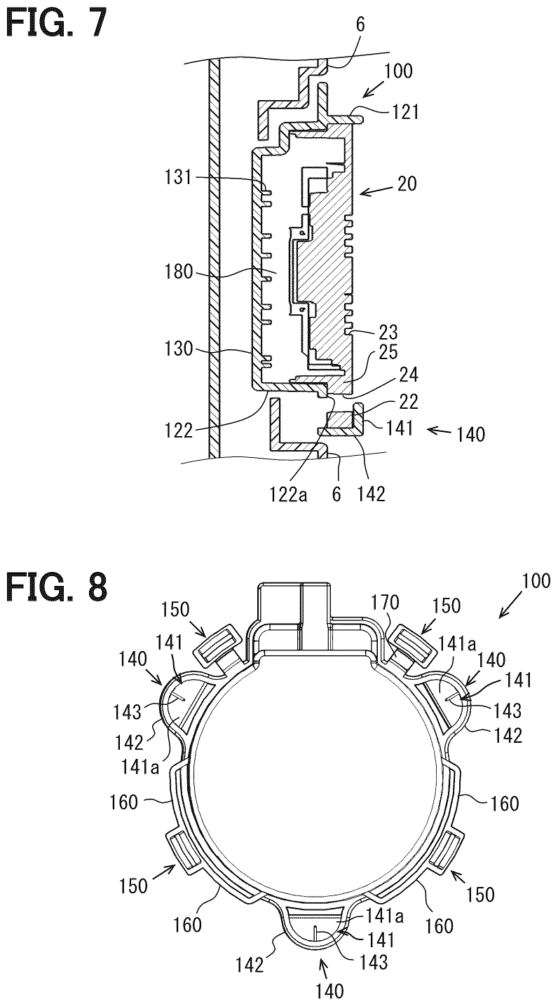

FIG. 6 is a plan view of the speaker unit 10, and FIG. 7 is a cross-sectional view taken along line VII-VII in FIG. 6. As shown in FIG. 7, in a state where the speaker 20 is received in the speaker vibration isolator 100, an enclosure space 180 is formed by: the back surface of the speaker 20; the back-side receiver portion 122; and the receiver bottom 130. In the state where the speaker 20 is received in the speaker vibration isolator 100, the end surface 122a of the receiver ring 120 contacts the back surface of the speaker flange 25, and thereby the enclosure space 180 becomes a closed space.

The retainers 140 radially outwardly project from the front-side receiver portion 121. Since the front-side receiver portion 121 is placed on the front side of the back-side receiver portion 122, the retainers 140 are also placed on the front side of the back-side receiver portion 122. The number of the retainers 140 formed at the speaker vibration isolator 100 is three, and each of the retainers 140 is located at a position that corresponds to the corresponding one of the speaker projections 22 of the speaker 20. Each retainer 140 has a front plate portion 141 and a peripheral plate portion 142. The front plate portion 141 is opposed to a front surface of the corresponding speaker projection 22. The front plate portion 141 is shaped in a plate form that has a semi-circular shape.

The peripheral plate portion 142 is joined to an arcuate edge of the front plate portion 141 and extends in the axial direction of the front-side receiver portion 121. The peripheral plate portion 142 is joined to the front-side receiver portion 121 at two opposite circumferential end parts of the peripheral plate portion 142 which are opposed to each other in the circumferential direction of the front-side receiver portion 121.

FIG. 8 is a bottom view of the speaker vibration isolator 100. As shown in FIG. 8, each retainer 140 has a rib 143. The rib 143 is shaped in a stick form (strip form) and linearly extends toward a radial center of the speaker vibration isolator 100 from a location adjacent to a radially outermost end of the front plate portion 141. A radially inner end of the rib 143 is located around the middle of the front plate portion 141. Therefore, the front plate portion 141 has a radially inner part 141a that faces the radial center of the speaker 20, and the rib 143 is not formed at the radially inner part 141a. A radially inner end surface of the rib 143 is preferably formed as a slope surface to ease installation of the speaker 20 to the speaker vibration isolator 100.

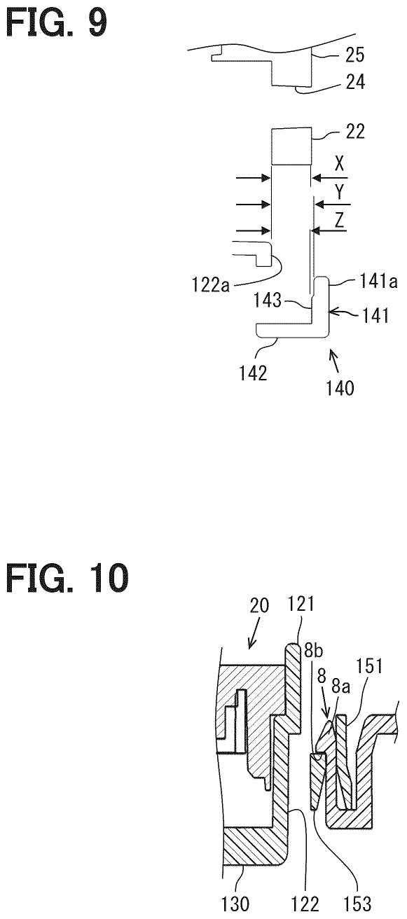

FIG. 9 is a diagram for describing a dimensional relationship between the speaker projection 22 and each corresponding portion of the speaker vibration isolator 100 which is opposed to the speaker projection 22. To illustrate the dimensional relationship, the speaker projection 22 and the speaker vibration isolator 100 are shown spaced from each other.

The rib 143 projects from a back surface of the front plate portion 141 and extends toward the corresponding speaker projection 22. As shown in FIG. 9, a thickness of the speaker projection 22, i.e., a distance measured between the front surface of the speaker projection 22 and the back surface of the speaker projection 22 (serving as a contact surface of the speaker projection 22 of the speaker 20 configured to contact the end surface 122a of the receiver ring 120) is denoted by X, and a distance measured in the axial direction between the end surface 122a and the radially inner part 141a is denoted by Y. Furthermore, an axial distance between the end surface 122a and the rib 143 is denoted by Z. The distance Z is a smallest distance between the end surface 122a of the back-side receiver portion 122 and the contact part of the retainer 140 to be in contact with the front surface of the speaker projection 22.

As shown in FIG. 9, there is a relationship of Z<X. Therefore, in the state where the speaker 20 is installed to the speaker vibration isolator 100, the end surface 122a of the back-side receiver portion 122, which faces the side where the retainers 140 are placed, contacts the back surface of the speaker flange 25. Furthermore, the rib 143 contacts the front surface of the speaker projection 22 and urges the speaker projection 22 toward the receiver ring 120 (more specifically, the back-side receiver portion 122). A height of the rib 143 is set such that a difference between the distance X and the distance Z enables easy elastic deformation of the speaker vibration isolator 100.

Furthermore, there is a relationship of X<Y. Therefore, at the time of installing the speaker 20 to the speaker vibration isolator 100, the speaker projection 22 can be moved relative to the retainer 140 with a small resistance until the speaker projection 22 contacts a distal end (radially inner end) of the rib 143. After the speaker projection 22 contacts the radially inner end of the rib 143, the resistance at the time of relative movement is increased by the amount that corresponds to the presence of the rib 143. However, since the speaker projection 22 is already partially opposed to the front plate portion 141, the axial position of the speaker projection 22 is unlikely to deviate even when an assembling worker applies a force. Since the speaker vibration isolator 100 is made of the elastic material, the speaker 20 can be installed to the speaker vibration isolator 100 without resulting in the positional deviation of the speaker 20 even when the assembling worker applies more force than before.

Each of the connectors 150 is configured to engage with the corresponding one of the planar pawls 8. The connector 150 is engaged with, i.e., is coupled with the planar pawl 8 in a state where the connector 150 receives the planar pawl 8. FIG. 5 is a plan view of the speaker vibration isolator 100. As shown in FIG. 5, each connector 150 has an outer wall portion 151, two opposed lateral wall portions 152 and an inner wall portion 153.

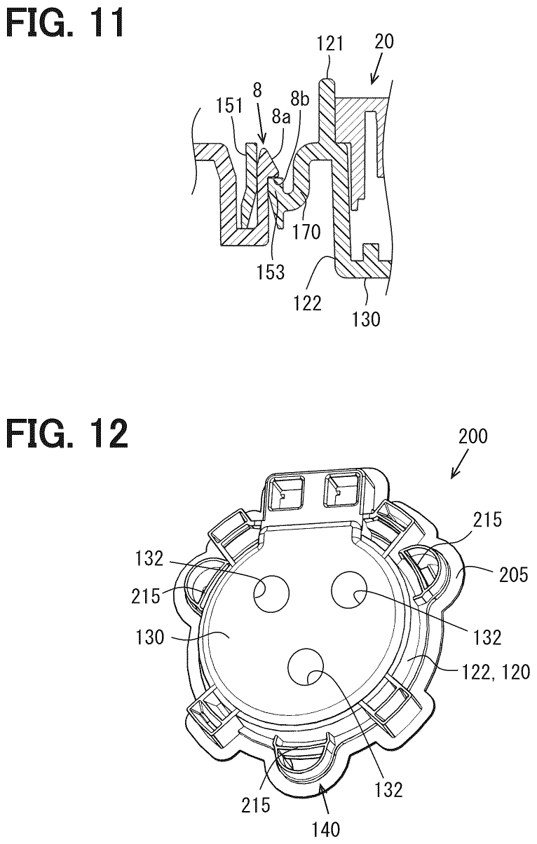

FIG. 10 is a cross-sectional view taken along line X-X in FIG. 6. FIG. 11 is a cross-sectional view taken along line XI-XI in FIG. 6. In the following description of FIGS. 10 and 11, the term “upper” and the term “lower” are used to refer the upper side and the lower side in the up-to-down direction in the drawing. Although each planar pawl 8 formed at the lower case 6 is shaped in a plate form, the planar pawl 8 has a distal end part 8a, a wall thickness of which is progressively decreased toward a distal end of the distal end part 8a, as shown in FIGS. 10 and 11. The distal end part 8a has a contact surface 8b that is configured to contact the inner wall portion 153 of the corresponding connector 150. At each connector 150, an axial size of the inner wall portion 153 is smaller than an axial size of the outer wall portion 151 in the axial direction of the speaker 20, and an upper end surface of the inner wall portion 153 is configured to contact the contact surface 8b of the corresponding planar pawl 8. Thereby, the movement of the speaker vibration isolator 100 toward the upper side is limited. Furthermore, the inner wall portion 153 and the outer wall portion 151 limit movement of the corresponding planar pawl 8 in the radial direction of the speaker vibration isolator 100.

A wall thickness of a lower part of the inner wall portion 153 is progressively decreased toward a lower end surface of the inner wall portion 153. With this configuration, the planar pawl 8 can be easily inserted between the inner wall portion 153 and the outer wall portion 151. The state where each planar pawl 8 is inserted between the inner wall portion 153 and the outer wall portion 151 of the corresponding connector 150 is a state where the speaker vibration isolator 100 is coupled to the lower case 6.

The number of the connectors 150 of the speaker vibration isolator 100 is four. Among the four connectors 150, each of two connectors 150 is coupled to the receiver ring 120 through the corresponding one of the circumferential links 160, and each of the remaining two connectors 150 is coupled to the receiver ring 120 through the corresponding one of the axial links 170.

Each of the circumferential links 160 is shaped in a thin plate form. The circumferential link 160 extends from the back-side receiver portion 122 in the circumferential direction of the back-side receiver portion 122, and the circumferential link 160 couples between the back-side receiver portion 122 and the corresponding connector 150. The circumferential link 160 forms a gap relative to the back-side receiver portion 122 placed adjacent to the circumferential link 160 in a thickness direction (a direction of a wall thickness) of the circumferential link 160. Here, the back-side receiver portion 122 serves as an adjacent member placed adjacent to the circumferential link 160 in the thickness direction of the circumferential link 160. Therefore, the circumferential link 160 can be elastically deformed to move toward or away from the back-side receiver portion 122.

Each of the axial links 170 is shaped in a plate form and extends in the axial direction of the speaker vibration isolator 100 from a lower end of the front-side receiver portion 121 toward the lower side and is joined to the inner wall portion 153 of the corresponding connector 150, as shown in FIG. 11. Furthermore, as shown in FIG. 11, the axial link 170 forms a gap relative to the back-side receiver portion 122 placed adjacent to the axial link 170 in a thickness direction (a direction of a wall thickness) of the axial link 170. Here, the back-side receiver portion 122 serves as an adjacent member placed adjacent to the axial link 170 in the thickness direction of the axial link 170. Also, the axial link 170 forms a gap relative to the inner wall portion 153 of the corresponding connector 150. Therefore, the axial link 170 can be elastically deformed to move toward or away from the back-side receiver portion 122.

### (Description of Vibration Isolating Effect)

Next, the vibration isolating effect of the speaker vibration isolator 100 will be described. The speaker vibration isolator 100 is entirely made of the elastic material. Therefore, the vibrations generated at the speaker 20 are damped as the vibrations travel along the speaker vibration isolator 100. Thus, it is possible to limit transmission of the vibrations, which are generated at the speaker 20, to the other member such as the lower case 6.

Furthermore, the speaker vibration isolator 100 includes: the receiver ring 120, which surrounds the outer peripheral surface of the speaker 20; and the retainers 140 that correspond to the three speaker projections 22, respectively. Furthermore, each of the retainers 140 is configured to contact the front surface of the corresponding speaker projection 22 and urge the corresponding speaker projection 22 toward the receiver ring 120. Since the retainers 140 urge the speaker projections 22 toward the back-side receiver portion 122, the speaker vibration isolator 100 can effectively hold the speaker 20.

Since the speaker vibration isolator 100 holds the speaker 20 in the above-described manner, the coupling between the speaker 20 and the speaker vibration isolator 100 is weaker than that of a case where the speaker 20 is fixed with the screws. Since the coupling described above is weak, it is possible to limit the transmission of the vibrations, which are generated at the speaker 20, to the other member, such as the lower case 6, through the speaker vibration isolator 100. Thus, the speaker vibration isolator 100 has the high vibration isolating effect.

In addition, since the speaker vibration isolator 100 holds the speaker 20 in the above-described manner, the standard speaker 20, which has the speaker projections 22 each having the through-hole 24 for secure attachment with the screw, can be used.

In the speaker vibration isolator 100, each of the circumferential links 160 and the axial links 170, each of which couples between the corresponding connector 150 and the speaker receiver 110, is shaped in the plate form. In addition, each of the circumferential links 160 and the axial links 170 forms the gap relative to the adjacent member which is adjacent to the link 160, 170 in the thickness direction of the link 160, 170. Therefore, in the case where the vibrations of the speaker 20 are transmitted to the circumferential links 160 and the axial links 170, the circumferential links 160 and the axial links 170 are vibrated. Thereby, at least some of the vibrations of the speaker 20 are absorbed by the circumferential links 160 and the axial links 170. Thus, with this configuration, it is possible to further limit the transmission of the vibrations, which are generated at the speaker 20, to the other member such as the lower case 6. Thus, the speaker vibration isolator 100 has the higher vibration isolating effect.

Furthermore, in the speaker vibration isolator 100, the enclosure space (serving as a back space) 180, which is located adjacent to the back surface of the speaker 20, is the closed space. This configuration can limit a reverse-phase sound from leaking out of the enclosure space 180. Therefore, it is possible to limit generation of a sound and vibrations caused by this sound when the reverse-phase sound is transmitted to the surroundings around speaker 20.

### Other Advantages

A circumferential position of each of the circumferential links 160 and the axial links 170 is different from a circumferential position of each of the retainers 140 at the speaker vibration isolator 100. Furthermore, radial positions of the circumferential links 160, the axial links 170 and the retainers 140 are generally identical to each other. With this configuration, the radial size of the speaker vibration isolator 100 can be reduced in comparison to a case where the positions of the circumferential links 160 or the axial links 170 overlap with the positions of the retainers 140 in the circumferential direction. In the case where the speaker unit 10 is installed to the meter unit 5, an available space for installing the speaker unit 10 is often limited. Therefore, with the above configuration, the speaker unit 10 can be more easily installed to the meter unit 5.

Furthermore, the circumferential links 160 and the axial links 170 are both used as the links. Therefore, all of the links can be easily placed at the different circumferential positions which are different from the circumferential positions of the retainers 140 in comparison to a case where only the circumferential links 160 are provided as the links.

In the speaker unit 10 of the present embodiment, the distance Z shown in FIG. 9 is smaller than the distance X. With this configuration, the retainers 140 can reliably urge the entire speaker 20 including the speaker projections 22 toward the back-side receiver portion 122. Thus, the end surface 122a of the back-side receiver portion 122 can more tightly contact the back surface of the speaker flange 25, and thereby the airtightness of the enclosure space 180 can be further increased. Therefore, by increasing the airtightness of the enclosure space 180, it is possible to further limit the generation of the sound and the vibrations caused by the transmission of the reverse-phase sound to the surroundings around speaker 20.

In the speaker unit 10 of the present embodiment, the distance Y shown in FIG. 9 is longer than the distance X. Therefore, the installation of the speaker 20 to the speaker vibration isolator 100 can be eased.

### Second Embodiment

Next, a second embodiment, which is a modification of the first embodiment, will be described. In the description of the second embodiment and the following embodiment(s), elements with the same reference signs as previously used are the same as elements with the same reference signs in the earlier embodiment(s), unless otherwise noted. Furthermore, when only a portion of a structure is described in the embodiment, the description of the rest of the structure described in the preceding embodiment may be applied to the rest of the structure.

FIG. 12 is a perspective view showing a back surface of a speaker vibration isolator 200 of the second embodiment. As shown in FIG. 12, the speaker vibration isolator 200 has a plurality of communicating portions (in this instance, three communicating portions) 132 formed at the receiver bottom 130. Each of the communicating portions 132 of the present embodiment is a through-hole that extends through the receiver bottom 130.

Since the communicating portions 132 are formed at the receiver bottom 130, the enclosure space 180 does not become the closed space in the second embodiment. In a case where the enclosure space 180 is relatively small, the bass (low frequency sound) may not be enhanced in some cases. As a countermeasure for this, the communicating portions 132 are formed to communicate the enclosure space 180 to an adjacent space which is adjacent to the enclosure space 180 in the state where the receiver bottom 130 is placed between the enclosure space 180 and the adjacent space. In other words, each of the communicating portions 132 is formed to communicate between the back surface of the speaker 20 and the space (i.e., the adjacent space) placed on the side of the receiver ring 20 that is farther from the speaker 20 than the receiver ring 120. There is no limit to the number of the communicating portions 132. For example, the number of the communicating portion(s) 132 may be one. Also, the size and the location of each of the communicating portions 132 are not limited to anyone. If the communicating portion 132 is enlarged and made the same size as the receiver bottom 130, there will be no receiver bottom 130.

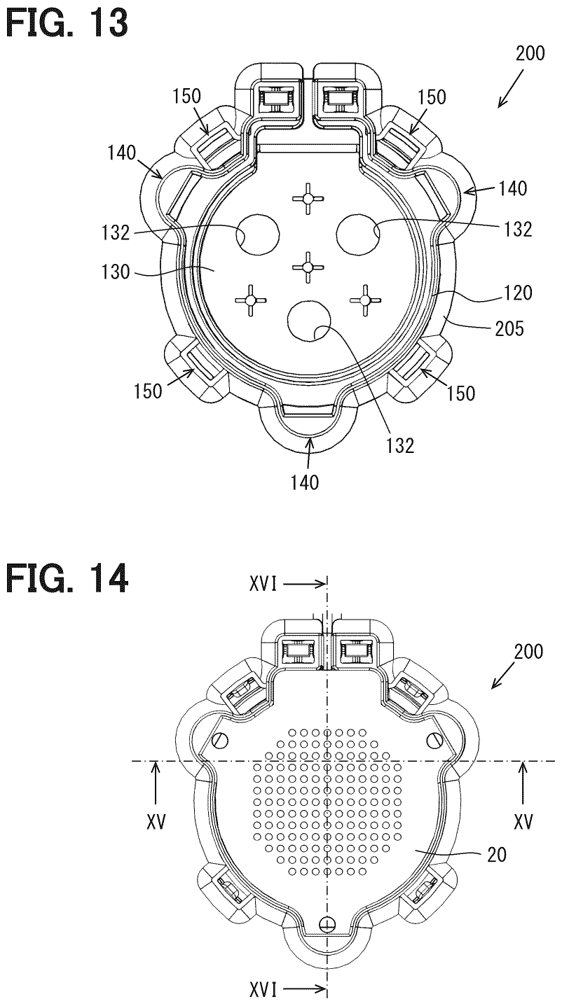

FIG. 13 is a diagram showing a surface of the speaker vibration isolator 200. At the speaker vibration isolator 200, each of the connectors 150 is directly fixed to the receiver ring 120 without using the link. As shown in FIGS. 12 and 13, the speaker vibration isolator 200 has a ring-shaped flange (also simply referred to as a flange) 205.

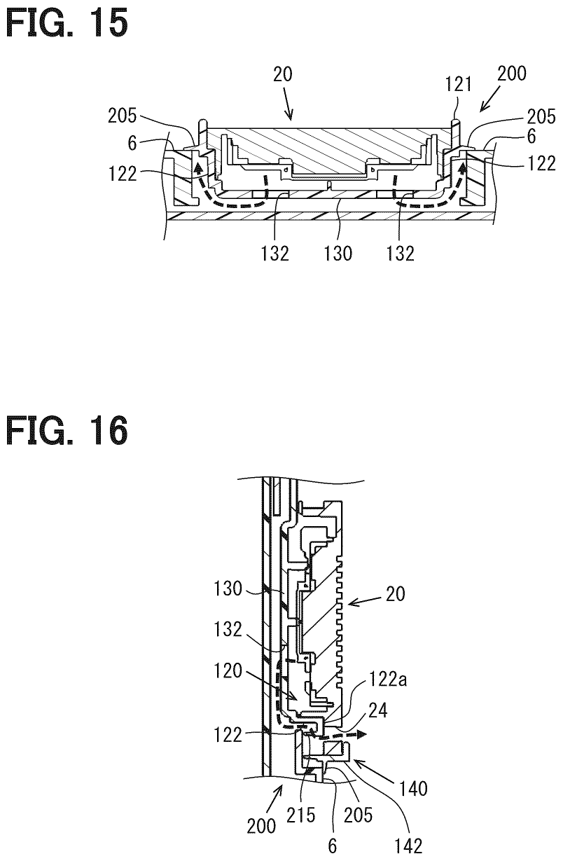

FIG. 14 is a plan view showing a state where the speaker 20 is held by the speaker vibration isolator 200. FIG. 15 is a cross-sectional view taken along line XV-XV in FIG. 14. FIG. 16 is a cross-sectional view taken along line XVI-XVI in FIG. 14.

The ring-shaped flange 205 radially outwardly projects from the receiver ring 120. Specifically, the ring-shaped flange 205 radially outwardly projects from a part of the front-side receiver portion 121 which is adjacent to the back-side receiver portion 122 at the receiver ring 120. The ring-shaped flange 205 radially outwardly projects from the peripheral plate portions 142 of the retainers 140 at the location where the retainers 140 are formed. The ring-shaped flange 205 is shaped in a ring form.

As shown in FIGS. 15 and 16, a distal end part (radially outer end part) of the ring-shaped flange 205 contacts a surface of the lower case 6. Furthermore, a thickness (wall thickness) of the ring-shaped flange 205 is progressively decreased toward the radially outer side.

As shown in FIG. 16, the speaker vibration isolator 200 has a plurality of blocking walls (in this instance, three blocking walls) 215. The blocking walls 215 are also shown in FIG. 12. As shown in FIG. 16, each of the blocking walls 215 extends from an outer periphery of the receiver ring 120. More specifically, each blocking wall 215 extends from the end surface 122a of the back-side receiver portion 122 to the outer periphery. A distal end part of the blocking wall 215 contacts the lower case 6. Furthermore, at the speaker vibration isolator 200 of the second embodiment, a distal end part of the peripheral plate portion 142 of each of the retainers 140 contacts the lower case 6.

At the speaker vibration isolator 200 having the above-described structure, since the communicating portions 132 are formed at the speaker vibration isolator 200, the sound generated at the speaker 20 leaks from the back surface of the speaker 20 to the outside of the enclosure space 180 through the communicating portions 132, as indicated by a dotted arrow in FIGS. 15 and 16.

However, the speaker vibration isolator 200 has the ring-shaped flange 205. The ring-shaped flange 205 blocks a gap between the receiver ring 120 and the lower case 6. Therefore, it is possible to limit the transmission of the sound, which leaks out of the enclosure space 180, toward the surface of the lower case 6 through the gap between the receiver ring 120 and the lower case 6.

Furthermore, the thickness (wall thickness) of the ring-shaped flange 205 is progressively decreased toward the radially outer side. With this configuration, the ring-shaped flange 205 can easily vibrate and absorb the sound in the case where the sound is transmitted to the ring-shaped flange 205. Therefore, the transmission of the sound to the surface of the lower case 6 is further limited.

Furthermore, the speaker vibration isolator 200 has the blocking walls 215. In a case where the blocking walls 215 are absent, the enclosure space 180 is communicated with the through-holes 24 through the communicating portions 132, as indicated by the dotted arrow in FIG. 16. Therefore, the sound, which is generated at the speaker 20, leaks from the through-holes 24, as indicated by the dotted arrow in FIG. 16.

However, at the speaker vibration isolator 200, each of the blocking walls 215 blocks between the back space of the speaker 20 and the corresponding one of the through-holes 24. Therefore, it is possible to limit the leakage of the sound, which is generated at the speaker 20, from the through-holes 24.

Furthermore, a thickness (wall thickness) of each blocking wall 215 is progressively decreased toward the lower case 6. With this configuration, the blocking wall 215 can easily vibrate and absorb the sound in the case where the sound is transmitted to the blocking wall 215. Therefore, the transmission of the sound to the surface of the lower case 6 is further limited.

Although the embodiments have been described above, the disclosed technology is not limited to the embodiments described above, and the following modifications are also included in the scope of the present disclosure. Furthermore, the technology can be implemented with various changes within the scope not departing from the gist other than the following.

For example, the number of the planar pawls 8 may be other than four. Instead of or in addition to the ribs 131, a plurality of pins may be formed at the receiver bottom 130 to contact the back surface of the speaker 20.

In addition, the communicating portions 132 of the second embodiment may be formed at the receiver bottom 130 of the first embodiment. In such a case, the ring-shaped flange 205 and the blocking walls 215 of the second embodiment may be formed at the speaker vibration isolator 100 of the first embodiment.

Furthermore, each of the connectors 150 of the first embodiment may be directly fixed to the receiver ring 120 without using the link like in the second embodiment. In addition, the connectors 150 of the second embodiment may be coupled to the receiver ring 120 by the circumferential links 160 and the axial links 170 of the first embodiment.

Also, in each of the first and second embodiments, one or more of the front plate portions 141 may be formed with or without the rib 143, as desired.

What is claimed is:

1. A speaker vibration isolator configured to receive a speaker having a plurality of speaker projections, wherein each of the plurality of speaker projections radially projects from a speaker main body of the speaker and has a through-hole configured to receive a screw through the through-hole, the speaker vibration isolator being made of an elastic material and comprising:
a receiver ring that is configured to surround an outer peripheral surface of the speaker; and
a plurality of retainers that correspond to the plurality of speaker projections, respectively, wherein each of the plurality of retainers is configured to contact a front surface of a corresponding one of the plurality of speaker projections and urge the corresponding one of the plurality of speaker projections toward the receiver ring.

2. The speaker vibration isolator according to claim 1, comprising:
at least one connector that is configured to be coupled with a mounting member to which the speaker vibration isolator is mounted; and
at least one link that couples between the receiver ring and the at least one connector, wherein:
at least a part of the at least one link is shaped in a plate form and forms a gap relative to an adjacent member of the speaker vibration isolator which is adjacent to the part of the at least one link in a thickness direction of the part of the at least one link.

3. The speaker vibration isolator according to claim 2, wherein the at least one link extends in a circumferential direction of the receiver ring.

4. The speaker vibration isolator according to claim 2, wherein the at least one link extends in an axial direction of the speaker vibration isolator.

5. The speaker vibration isolator according to claim 2, wherein a circumferential position of the at least one link is different from a circumferential position of each of the plurality of retainers.

6. The speaker vibration isolator according to claim 5, wherein:
the at least one connector is a plurality of connectors;
the at least one link is a plurality of links which correspond to the plurality of connectors, respectively;
at least one of the plurality of links extends in a circumferential direction of the receiver ring;
at least another one of the plurality of links extends in an axial direction of the speaker vibration isolator; and
the circumferential position of each of the plurality of links is different from the circumferential position of each of the plurality of retainers.

7. The speaker vibration isolator according to claim 1, comprising a receiver bottom that is configured to be opposed to a back surface of the speaker and cooperates with the receiver ring to form a closed space relative to the back surface of the speaker.

8. The speaker vibration isolator according to claim 7, wherein:
an end surface of the receiver ring, which faces a side where the plurality of retainers are placed, is configured to contact the speaker; and
a distance, which is measured between the end surface of the receiver ring and a contact part of one of the plurality of retainers configured to contact the front surface of the corresponding one of the plurality of speaker projections, is smaller than a distance, which is measured between a contact surface of the speaker configured to contact the receiver ring and the front surface of one of the plurality of speaker projections configured to contact the corresponding one of the plurality of retainers.

9. The speaker vibration isolator according to claim 8, wherein:
each of the plurality of retainers has:
a front plate portion that is shaped in a planar plate form and is configured to be opposed to the front surface of the corresponding one of the plurality of speaker projections; and
a rib that projects from the front plate portion toward the corresponding one of the plurality of speaker projections;
at each of the plurality of retainers, the front plate portion has a radially inner part that faces a radial center of the speaker, wherein the rib is not formed at the radially inner part; and
a distance, which is measured in an axial direction of the speaker vibration isolator between the radially inner part of one of the plurality of retainers and the end surface of the receiver ring, is larger than the distance, which is measured between the contact surface of the speaker configured to contact the receiver ring and the front surface of the one of the plurality of speaker projections configured to contact the corresponding one of the plurality of retainers.

10. The speaker vibration isolator according to claim 1, comprising:
a communicating portion that communicates between a back surface of the speaker and a space placed on a side of the receiver ring that is farther from the speaker than the receiver ring; and
a ring-shaped flange that is shaped in a ring form and radially projects from the receiver ring and is configured to contact a surface of a mounting member to which the speaker vibration isolator is mounted.

11. The speaker vibration isolator according to claim 10, wherein a thickness of the ring-shaped flange is progressively decreased toward a radially outer side.

12. The speaker vibration isolator according to claim 10, comprising at least one blocking wall that extends from an outer periphery of the receiver ring, wherein a distal end part of the at least one blocking wall is configured to contact the mounting member and thereby block between the through-hole of a corresponding one of the plurality of speaker projections and a back space located adjacent to the back surface of the speaker.

13. The speaker vibration isolator according to claim 12, wherein a thickness of the at least one blocking wall is progressively decreased toward the mounting member.

14. The speaker vibration isolator according to claim 1, wherein:
each of the plurality of retainers has a front plate portion and a rib, wherein at each of the plurality of retainers, the rib projects from a back surface of the front plate portion toward the corresponding one of the plurality of speaker projections; and
the rib of each of the plurality of retainers is configured to contact the front surface of the corresponding one of the plurality of speaker projections and urge the corresponding one of the plurality of speaker projections toward the receiver ring.
